(19) United States
(12) Patent Application Publication
(10) Pub. No.: US 2015/0210125 A1
(43) Pub. Date: Jul. 30, 2015

(54) TIRE PRESSURE SENSOR DEVICE SETTING METHOD

(71) Applicant: Club Elecparts Inc., Changhua County (TW)

(72) Inventors: San-Chuan YU, Changhua County (TW); Tsan-Nung WANG, Changhua County (TW); Chao-Ching HU, Tainan City (TW); Chi-Hung CHEN, Changhua County (TW)

(73) Assignee: Club Elecparts Inc., Changhua County (TW)

(21) Appl. No.: 14/226,152

(22) Filed: Mar. 26, 2014

(30) Foreign Application Priority Data
Jan. 27, 2014 (TW) 103100543

(51) Int. Cl. B60C 23/04; G06K 7/10

(52) U.S. Cl. CPC B60C 23/0472; G06K 7/10198; B60C 23/0479

(57) ABSTRACT

A tire pressure sensor device setting method is disclosed to use a setting tool to encode the tire pressure sensor device to be set and to simultaneously write the location information of the tire pressure sensor device into the communication protocol during encoding, enabling the tire pressure sensor device to actively send out a location signal.

### BACKGROUND OF THE INVENTION

1. Field of the Invention

The present invention relates to tire pressure monitoring technology and more particularly, to a method for setting a tire pressure sensor device.

2. Description of the Related Art

To improve driving safety, a vehicle may be equipped with a tire pressure monitoring system. A tire pressure sensor device is adapted to detect various statuses of the respective tire, such as temperature, pressure, and etc., and then to transmit detected data to an on-vehicle main unit in the motor vehicle in a wireless manner, so that the driver can know the current status of every tire of the motor vehicle. Sensor ICs are commonly used for sensing tire pressure and temperature, A sensor IC for tire pressure monitoring system may have a G sensor built therein for measuring the amount of acceleration of the motor vehicle; however, the data provided by the G sensor cannot be used to determine the location of the tire.

Some commercial tire pressure sensor devices have a particular design for determining tire location. For example, a multi-axis G sensor can be installed in a tire pressure sensor device to measure the amount of acceleration in two or three axes for calculation so that the location of the tire pressure sensor device can be deter mined. A mechanical tilting or moving mechanism can also be used to help determine the location of the tire pressure sensor device. However, the application of these conventional methods needs to install an additional structure or device in the tire pressure sensor device for the determination of individual location. Currently there is no any other convenient method for determining the location of each individual tire.

### SUMMARY OF THE INVENTION

The present invention has been accomplished under the circumstances in view. It is the main object of the present invention to provide a tire pressure sensor device setting method, which enables the on-vehicle main unit to rapidly determine the left-sided or right-sided location of the tire that carries the tire pressure sensor device.

To achieve this and other objects of the present invention, a tire pressure sensor device setting method includes the step of providing a tire pressure sensor device setting tool that comprises a user interface for operation by a user, the step of operating the tire pressure sensor device setting tool to select vehicle brand, vehicle model and model year, the step of inputting the ID (identification) code of the tire pressure sensor device to be set into the tire pressure sensor device setting tool, the step of selecting the option of right-sided tire or left-sided tire, the step of tire pressure sensor setting tool editing the data of vehicle brand, vehicle model and model year, the data of the ID code of the tire pressure sensor device and the content of the data of the selected option of right-sided tire or left-sided tire into a communication protocol, and the step of writing the communication protocol into the tire pressure sensor device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an operational flow chart of a tire pressure sensor device setting method in accordance with the present invention.

### DETAILED DESCRIPTION OF THE INVENTION

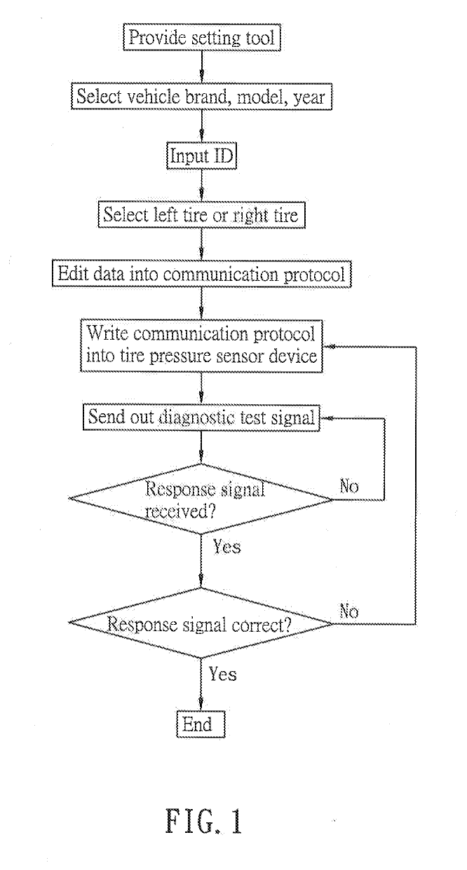

Referring to FIG. 1, a tire pressure sensor device position setting method in accordance with the present invention comprises the steps stated below.

At first provide a setting tool having a user interface through which a user can set the setting tool.

Thereafter, operate the setting tool to select the vehicle brand, vehicle model and model year without sequential constraints.

Thereafter, input the ID (identification) code of the tire pressure sensor device into the setting tool after selection of the vehicle brand, vehicle model and model year. Inputting the ID code can be achieved in any of a variety of known techniques. A wireless ID code reading technique or optical barcode scanning technique can be employed, enabling the setting tool to get the ID code of the tire pressure sensor device. Alternatively, the ID code of the tire pressure sensor device can be inputted into the setting tool manually.

After inputted the ID code of the tire pressure sensor device into the setting tool, select the option of Right-sided or Left-sided. This option selection procedure is to determine the tire pressure sensor device to be installed on the left or right side of the vehicle. After selection of the option, the setting tool will then edit the data of vehicle brand, vehicle model and model year, the ID code of the tire pressure sensor device and the content of the selected option into a communication protocol. Further, the step of operating the setting tool to select the vehicle brand, vehicle model and model year and the step of inputting the ID (identification) code of the tire pressure sensor device into the setting tool are sequentially exchangeable, i.e., the user can input the ID (identification) code of the tire pressure sensor device into the setting tool at first, and then operate the setting tool to select the vehicle brand, vehicle model and model year.

Thereafter, write the communication protocol into the tire pressure sensor device. Writing the communication protocol into the tire pressure sensor device can be done by using a cable to load the communication protocol onto the tire pressure sensor device. Alternatively, a wireless transmission technique can be employed to transmit the communication protocol from the setting tool to the tire pressure sensor device.

After loading of the communication protocol on the tire pressure sensor device, the setting tool will give a diagnostic test signal to the tire pressure sensor device. After received the diagnostic test signal, the tire pressure sensor will send a response signal back to the setting tool. This response signal contains the ID code of the tire pressure sensor, the temperature and pressure data measured by the tire pressure sensor device and the Right-sided or Left-sided setting data. Thus, subject to the content of the response signal, the setting tool can determine whether the setting of the tire pressure sensor device is completed.

The tire pressure sensor device setting method of the present invention facilitates quick setting of a tire pressure sensor device in a left or right tire of a motor vehicle. Subject to the application of the tire pressure sensor device setting method of the present invention, a tire pressure sensor device manufacturer needs not to install any additional means in a tire pressure sensor device for identification of left-sided or right-sided mounting application. Therefore, the invention effectively improves the problem of conventional techniques in determining the left-sided or right-sided mounting location of a tire pressure sensor device.

What is claimed is:

1. A tire pressure sensor device setting method, comprising the steps of:
(a) providing a tire pressure sensor device setting tool that comprises a user interface for operation by a user;
(b) operating said tire pressure sensor device setting tool to select vehicle brand, vehicle model and model year;
(c) inputting the ID (identification) code of the tire pressure sensor device to be set into said tire pressure sensor device setting tool;
(d) selecting the option of right-sided tire or left-sided tire;
(e) said tire pressure sensor device setting tool editing the data of vehicle brand, vehicle model and model year, the ID code of said tire pressure sensor device and the content of the selected option of right-sided tire or left-sided tire into a communication protocol; and
(f) writing said communication protocol into said tire pressure sensor device.

2. The tire pressure sensor device setting method as claimed in claim 1, wherein the step of inputting the ID (identification) code of said tire pressure sensor device to be set into said tire pressure sensor device setting tool is to employ a wireless technique, enabling said tire pressure sensor device setting tool to read in the ID (identification) code of said tire pressure sensor device.

3. The tire pressure sensor device setting method as claimed in claim 1, wherein the step of inputting the ID (identification) code of said tire pressure Sensor device to be set into said tire pressure sensor device setting tool is to employ an optical barcode scanning technique, enabling said tire pressure sensor device setting tool to read in the ID (identification) code of said tire pressure sensor device.

4. The tire pressure sensor device setting method as claimed in claim 1, wherein the step of inputting the ID (identification) code of said tire pressure sensor device to be set into said tire pressure sensor device setting tool is to manually input the ID (identification) code of said tire pressure sensor device into said tire pressure sensor device setting tool.

5. The tire pressure sensor device setting method as claimed in claim 1, wherein the step of writing said communication protocol into said tire pressure sensor device is done by using a cable to download said communication protocol from said tire pressure sensor device setting tool onto said tire pressure sensor device.

6. The tire pressure sensor device setting method as claimed in claim 1, wherein the step of writing said communication protocol into said tire pressure sensor device is done by employing a wireless transmission technique to transmit said communication protocol from said tire pressure sensor device setting tool to said tire pressure sensor device.

7. The tire pressure sensor device setting method as claimed in claim 1, wherein after the step of writing said communication protocol into said tire pressure sensor device, said tire pressure sensor device setting tool provides a diagnostic test signal to said tire pressure sensor device.

8. The tire pressure sensor device setting method as claimed in claim 7, wherein said tire pressure sensor sends a response signal back to said tire pressure sensor device setting tool after received said diagnostic test signal from said tire pressure sensor device setting tool.

9. The tire pressure sensor device setting method as claimed in claim 8, wherein said response signal contains the ID (identification) code of said tire pressure sensor and the data of selected option of right-sided tire or left-sided tire.

10. The tire pressure sensor device setting method as claimed in claim 1, wherein step (b) of operating said tire pressure sensor device setting tool to select vehicle brand, vehicle model and model year and step (c) of inputting the ID (identification) code of the tire pressure sensor device to be set into said tire pressure sensor device setting tool are sequentially exchangeable.
